(19) United States
(12) Patent Application Publication
(10) Pub. No.: US 2018/0131533 A1
(43) Pub. Date: May 10, 2018

(54) AUTOMATION RULE SELECTION METHOD AND WIRELESS COMMUNICATION DEVICE

(71) Applicant: Sercomm Corporation, Taipei City (TW)

(72) Inventors: Yu-Li Shen, Taipei City (TW); Kuo-Liang Tseng, Taipei City (TW); Chin-Fong Shih, Taipei City (TW)

(21) Appl. No.: 15/724,379

(22) Filed: Oct. 4, 2017

(30) Foreign Application Priority Data
Nov. 9, 2016 (CN) 201610985952.2

(51) Int. Cl. H04L 12/28; H04L 29/08; H04M 1/725

(52) U.S. Cl. CPC H04L 12/282; H04M 1/72533; H04L 67/18

(57) ABSTRACT

An automation rule selection method and a wireless communication device are provided. The automation rule selection method includes following steps. A first type indicator and a first location indicator of a first device are obtained. A second type indicator and a second location indicator of a second device are obtained. If the first location indicator and the second location indicator satisfy the location restraint, then an automation rule is selected from a plurality of candidate automation rules according to the first type indicator and the second type indicator.

This application claims the benefit of People's Republic of China application Serial No. 201610985952.2, filed Nov. 9, 2016, the subject matter of which is incorporated herein by reference.

### BACKGROUND OF THE INVENTION

### Field of the Invention

The invention relates in general to an automation rule, and more particularly to an automation rule selection method.

### Description of the Related Art

Along with the rapid advance in technology, smart home application has gained booming development. A smart home system may include multiple smart home devices, such as door/window sensor, temperature sensor, Internet Protocol (IP) camera, curtain controller, illumination controller, and smart plug. The user can control the smart home devices, for example, through an APP installed in a mobile phone or tablet computer. As the variety of smart home devices increases, how to effectively make the smart home devices work automatically according to pre-set rules has become a prominent task for the industries.

### SUMMARY OF THE INVENTION

The present invention is directed to an automation rule selection method and a wireless communication device for selecting an automation rule suitable for multiple devices.

According to one embodiment of the present invention, an automation rule selection method is provided. The automation rule selection method includes following steps. A first type indicator and a first location indicator of a first device are obtained. A second type indicator and a second location indicator of a second device are obtained. If the first location indicator and the second location indicator satisfy the location restraint, then an automation rule is selected from a plurality of candidate automation rules according to the first type indicator and the second type indicator.

According to another embodiment of the present invention, a wireless communication device is provided. The wireless communication device includes a signal transceiver and a processor. The signal transceiver is used for obtaining a first type indicator and a first location indicator of a first device, and obtaining a second type indicator and a second location indicator of a second device. The processor is electrically coupled to the signal transceiver and used for performing following operations. If the first location indicator and the second location indicator satisfy a location restraint, then an automation rule is selected from a plurality of candidate automation rules according to the first type indicator and the second type indicator if the first location indicator and the second location indicator satisfy the location restraint.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flowchart of an automation rule selection method according to an embodiment of the invention.

FIG. 2 is a schematic diagram of a wireless communication device according to an embodiment of the invention.

FIG. 3 is a flowchart of an automation rule selection method according to an embodiment of the invention.

FIG. 4 is a schematic diagram of an indoor region according to an embodiment of the invention.

FIG. 5 is a schematic diagram of a smart home system according to an embodiment of the invention.

### DETAILED DESCRIPTION OF THE INVENTION

In the smart home application, the automatic or smart interaction between multiple smart home devices is very important. If the user wants a smart home device to be automatically activated according to specific conditions, the user needs to input an automation rule to the smart home system. Examples of the automation rule includes: turning on the illumination device at the living room when the front door sensor senses that the door is opened; activating the alarm when the motion sensor is in an armed state and senses a motion. The user normally needs to input the automation rule to the smart home system to specify which of the smart home devices needs to be activated to perform corresponding operations when a certain event occurs, such the corresponding smart home devices could collaborate automatically. In this disclosure, an automation rule is defined as a rule that specifies how two or more electronic devices collaborate with each other without human intervention. For example, an automation rule may specify that when a first device detects a specific situation, a second device should have a specific action automatically without human intervention.

However, as the number of smart home devices increases, it becomes more difficult for the user to specify the automation rule without making mistakes. In an exemplary scenario of use, the user's house has three rooms and each room has an IP camera and a PIR sensor. In an example, when the user wants to specify interactions between the six smart home devices, the physical address or the media access control (MAC) address of each device needs to be specified in the automation rule and the interactions between the devices must be clearly defined. However, such a setting process is too complicated and too difficult for most users, and many erroneous settings may occur. To resolve the above problems, an automation rule selection method and a wireless communication device using the same are provided in the invention, and detailed descriptions are disclosed below.

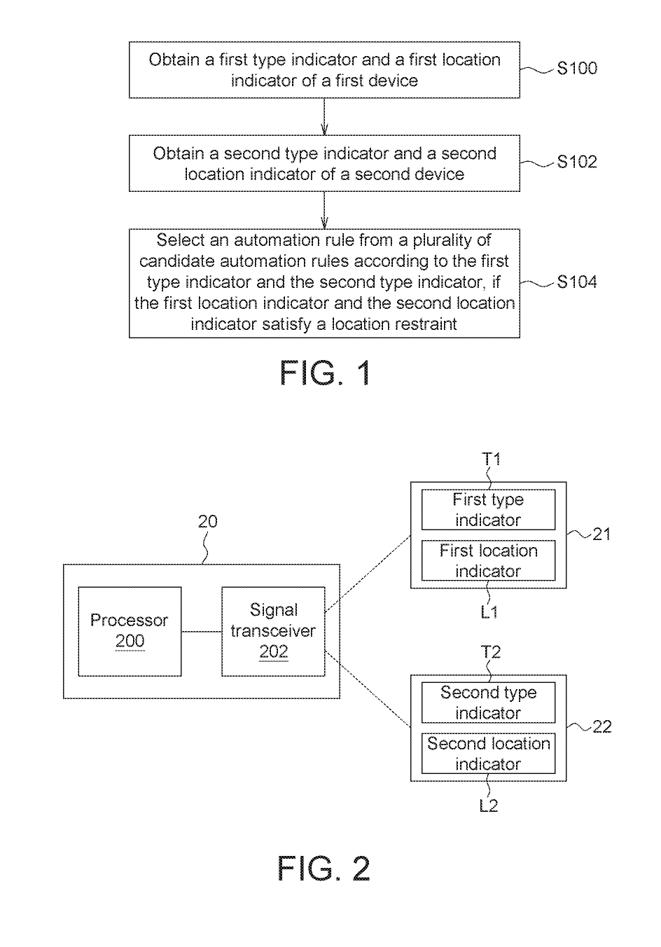

FIG. 1 is a flowchart of an automation rule selection method according to an embodiment of the invention. In step S100, a first type indicator and a first location indicator of a first device are obtained. In step S102, a second type indicator and a second location indicator of a second device are obtained. In step S104, if the first location indicator and the second location indicator satisfy a location restraint, then an automation rule is selected from a plurality of candidate automation rules according to the first type indicator and the second type indicator. Note that depending on the first type indicator and the second type indicator, zero, one, or multiple automation rules may be selected for the first device and second device.

In an embodiment, the method as indicated in FIG. 1 can be automatically executed by an automation controller or automation server, whether in the local network or the cloud. For example, the method is performed by a wireless communication device capable of wireless communication, and can be realized by such as a smart home device, a home gateway, a server, a tablet computer, or a smart phone. In another embodiment, the method as indicated in FIG. 1 can be executed by the first device or the second device. An embodiment of the wireless communication device executing the method as indicated in FIG. 1 is disclosed below with FIG. 2.

FIG. 2 is a schematic diagram of a wireless communication device according to an embodiment of the invention. The wireless communication device 20 includes a signal transceiver 202 and a processor 200. The signal transceiver 202 is used for obtaining a first type indicator T1 and a first location indicator L1 of a first device 21 and obtaining a second type indicator T2 and a second location indicator L2 of a second device 22. The processor 200 is electrically coupled to the signal transceiver 202, and is used for selecting an automation rule from a plurality of candidate automation rules according to the first type indicator T1 and the second type indicator T2 if the first location indicator L1 and the second location indicator L2 satisfy the location restraint. The signal transceiver 202 can be realized by a circuit capable of transmitting/receiving data via a wired or wireless network. The signal transceiver 202 may include a network interface card, a radio-frequency circuit, and an antenna.

In the present embodiment, for exemplary and explanatory purpose, the wireless communication device 20 is a home gateway, and the first device 21 and the second device 22 are smart home devices. In an embodiment, the automation rule selection method as indicated in FIG. 1 can be executed by the first device 21 or the second device 22 alone without using the wireless communication device 20. For example, the first device 21 can be connected to an external network or can have a processing circuit capable of executing the automation rule selection method. The automation rule selection method of the invention, which is used in the smart home application for exemplary purpose only, can also be used in other technology fields.

In the smart home application, multiple smart home devices can communicate with each other, whether directly or indirectly, using the wireless transmission technology such as ZigBee, Z-Wave, Wi-Fi, Bluetooth, and DECT ULE technology. The smart home can have a central control home gateway, such as the wireless communication device 20 as indicated in FIG. 2, for controlling relevant operations of each smart home device and connecting to an external network.

In step S100, the signal transceiver 202 of the wireless communication device 20 can obtain the first type indicator T1 and the first location indicator L1 of the first device 21 by way of wireless transmission. For example, the first device 21 already has the first type indicator T1 before leaving the factory. For example, an IP camera belongs to the visual surveillance type; a PIR sensor belongs to the intrusion detection type; a water level sensor and a smoke sensor belong to the disaster prevention type. After the first device 21 is installed, the first location indicator L1 of the first device 21 can be obtained. In an embodiment, the first location indicator L1, such as the room and the floor at which the first device 21 is installed, can be inputted by the user via an APP of a mobile phone. In another embodiment, the first location indicator L1 can be obtained by the signal transceiver 202 of the wireless communication device 20 according to the wireless signal transmitted by the first device 21. For example, the spatial coordinates of the first device 21 can be obtained using the indoor positioning technology and serve as the first location indicator L1.

Likewise, in step S102, after the second device 22 is installed, the wireless communication device 20 can obtain the second type indicator T2 and the second location indicator L2 of the second device 22.

Then, in step S104, whether the first location indicator Li and the second location indicator L2 satisfy the location restraint is determined by the processor 200 of the wireless communication device 20. The location restraint relates to the correlation between the location of the first device 21 and the location of the second device 22 and can be defined in advance. For example, if both the first device 21 and the second device 22 are installed at the same room, then it can be determined that the location of the first device 21 and the location of the second device 22 are correlated. If the first location indicator L1 and the second location indicator L2 satisfy the location restraint, this implies that it may be appropriate for the first device 21 and the second device 22 to collaborate with each other. Hence, one or more automation rules applicable to the first device 21 and the second device 22 can be selected from the candidate automation rules.

The candidate automation rules can be pre-stored in the wireless communication device 20 or a remote device such as a cloud server. The signal transceiver 202 of the wireless communication device 20 can download the candidate automation rules from the remote device via a wired or a wireless network connection (such as the Internet), and the suitable automation rule can be selected from the downloaded candidate automation rules. In another example, the signal transceiver 202 of the wireless communication device 20 uploads the first type indicator T1 and the second type indicator T2 to the remote device, and after the remote device has selected the suitable automation rule, the signal transceiver 202 of the wireless communication device 20 will download the selected automation rule.

As mentioned, one or more automation rules relevant to the first type indicator T1 and the second type indicator T2 may be selected from the candidate automation rules. In an embodiment, the candidate automation rules can be stored in a lookup table. The columns of the lookup table may include Type 1, Type 2, and Rule. For example, an exemplary row of the lookup table may include following columns: Type 1: intrusion detection; Type 2: visual surveillance; Rule: when the Type 1 device detects an event, the Type 2 device captures and uploads a snapshot image or a video. Another exemplary row of the lookup table may include following columns: Type 1: disaster prevention; Type 2: alarm; Rule: when the Type 1 device detects an event, the Type 2 device produces a siren sound. Therefore, after the first type indicator T1 and the second type indicator T2 are obtained, one or more rules may be selected from the candidate automation rules.

In an embodiment, the first type indicator T1 and the second type indicator T2 may include multiple levels of categorization. For example, a type called safety can be divided into anti-theft, disaster prevention, and monitoring; the disaster prevention type can further be divided into water sensing, smoke sensing, and gas sensing. Therefore, each candidate automation rule can record multiple levels of the categorization, and the suitable automation rule can be selected according to each level of the categorization. For example, the suitable automation rule can be selected from the bottommost level of the categorization. If no suitable automation rule is found, the selection of the suitable automation rule can move to a higher level of the categorization.

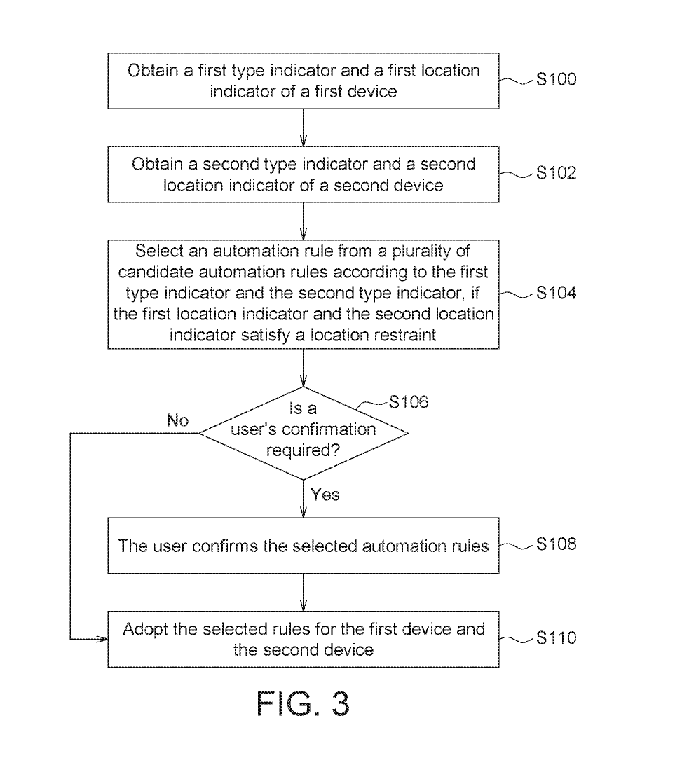

After the suitable automation rule is selected, the selected automation rule can be adopted directly or can be recommended to the user. The recommended automation rule will be adopted after the user's confirmation. FIG. 3 is a flowchart of an automation rule selection method according to an embodiment of the invention. After the automation rule is selected in step S104, the method proceeds to step S106, whether the user's confirmation is required is determined. The determination step S106 can be based on the factors such as the design requirements of the smart home system and the probability of the selected automation rules being adopted. If it is determined that user's confirmation is not required, then the method proceeds to step S110, the selected automation rule is adopted for the first device 21 and the second device 22. If it is determined that user's confirmation is required, then the method proceeds to step S108 to wait for the user's confirmation. In step S108, the selected automation rule is expressed using text, picture or drawing and is displayed on an APP of a mobile phone for the user to click and determine whether to confirm or decline the recommended automation rule. If the user's confirmation is received, the method proceeds to step S110.

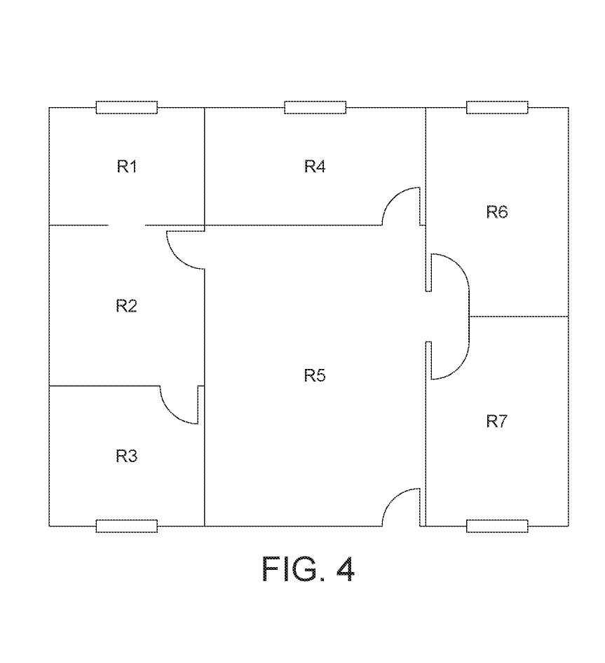

The location restraint in step S104 may have different ways of implementation. In an embodiment, the location restraint is that: the first location indicator L1 and the second location indicator L2 indicates that the first device 21 and the second device 22 belong to the same region. FIG. 4 is a schematic diagram of indoor regions of a house. In the present example, the house can be divided into rooms R1 to R7. For example, the room R1 is a kitchen, the room R2 is a dining room, the room R3 is a small bedroom, the room R4 is a bath room, the room R5 is a living room, the room R6 is an office, and the room R7 is a main bedroom. If the first location indicator L1 and the second location indicator L2 indicate that both the first device 21 and the second device 22 are installed at the room R6, the location restraint may be satisfied, and the method can search for the suitable automation rules.

When “the same region” is used as a location restraint, the devices within the same region can activate each other. This is a very common application in everyday life. For example, when the PIR sensor at the living room detects an abnormal event, the PIR sensor can directly or indirectly inform the IP camera at the living room to capture and upload a snapshot image or a video. If multiple illumination devices and a light switch are installed at the same office, the switch can be automatically set as an activation device for the illumination devices. When a water level sensor installed at the storage room detects that the water level is abnormal, the alarm or the drainage device installed at the storage room can be activated. Therefore, when “the same region is used” as a location restraint, the automation rule that is likely to be used can be selected.

In an embodiment, the definition of a region is not limited to a single room. For example, the room R1 (such as an open type kitchen) and the room R2 can be defined as the same region. Moreover, the entire house can be defined as a region, and the exterior of the house can be defined as another region. In an embodiment, when the user inputs the first location indicator Li of the first device 21 via a mobile phone, the APP provides the region list for the user to click and select. For example, if the user wants an IP camera exclusive for the use at the room R5, then the user can click the room R5 as the region of the IP camera. If the user wants an alarm to serve the entire house, that is, the alarm will be informed wherever an abnormal event is detected within the house, then the user can click the entire house as the region of the alarm.

In the above example of the smart home application, the region can be defined according to the rooms. The automation rule selection method of the invention is not restrictively used in the smart home system, and can also be used in the Internet of things (IoT) or the low power wide area (LPWA) network. Therefore, the application field is not limited to the household environment. For example, when the automation rule selection method of the invention is used in a department store, the ground floor can be viewed as a region, and the men's wear zone, the women's wear zone, the food court zone, the electrical appliance zone can respectively be viewed as different regions. When the automation rule selection method of the invention is used in a playground, each theme area can be viewed as a region. When the automation rule selection method of the invention is used in a city, each district can be viewed as a region.

In another embodiment, the location restraint used in step S104 is that: the first location indicator L1 and the second location indicator L2 indicate that a distance between the first device 21 and the second device 22 is shorter than a distance threshold. For example, in the smart home application, the spatial coordinates of the first device 21 and the second device 22 can be obtained by the indoor positioning technology and used as the first location indicator L1 and the second location indicator L2; in the outdoor environment, the spatial coordinates of the first device 21 and the second device 22 can be obtained by the global navigation satellite system (GLASS) and used as the first location indicator L1 and the second location indicator L2. After the spatial coordinates are obtained, the distance between the first device 21 and the second device 22 can be calculated, and when the distance between the first device 21 and the second device 22 is small enough, the automation rule related to the first type indicator T1 and the second type indicator T2 can be selected. Given that the location restraint is based on the distance, when two smart home devices are installed nearby or when two mobile devices are close to each other, the corresponding automation rule can be selected.

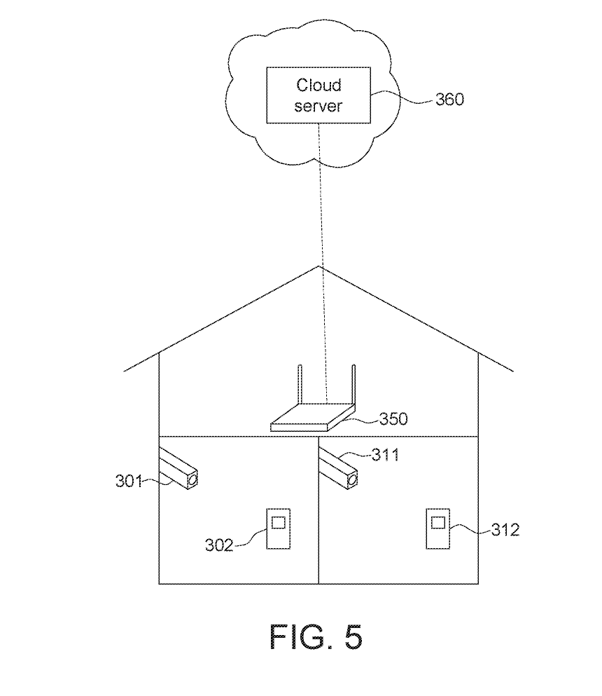

FIG. 5 is a schematic diagram of a smart home system according to an embodiment of the invention. The automation rule selection method as indicated in FIG. 1 and FIG. 3 is exemplified with FIG. 5. The smart home system as indicated in FIG. 5 includes a first IP camera 301, a first PER sensor 302, a second IP camera 311, a second PIR sensor 312, and a home gateway 350. The first IP camera 301 and the first PIR sensor 302 are installed at the first room. The second IP camera 311 and the second PER sensor 312 are installed at the second room. The home gateway 350 is installed at the third room, and can be connected to a cloud server 360 via a network connection.

The home gateway 350 may be responsible for performing the method shown in FIG. 1 or FIG. 3. Specifically, the home gateway 350 can obtain the type indicators and the location indicators of the first IP camera 301, the first PIR sensor 302, the second IP camera 311, the second PIR sensor 312 (step S100 and step S102), and can determine that the first IP camera 301 and the first PIR sensor 302 belong to the same region, and the second IP camera 311 and the second PIR sensor 312 belong to the same region. Then the home gateway 350 selects an automation rule Rule 1 (step S104) from the candidate automation rules stored in the cloud server 360 according to the type of the first IP camera 301 (visual surveillance type) and the type of first PIR sensor 302 (intrusion-detection type). In practice, the cloud server could 360 selects the automation rule Rule 1 according to the type indicators uploaded by the home gateway 350, and then transmits the selected automation rule Rule 1 to the home gateway 350. The home gateway 350 can directly adopt the automation rule Rule 1 for the first IP camera 301 and the first PIR sensor 302 (step S110), or the automation rule Rule 1 is recommended to the user via an APP of a mobile phone and the recommended automation rule Rule 1 is adopted after the user's confirmation is received (step S110). For example, the selected Rule 1 may specify that whenever the PIR 302 detects motion, the IP camera 301 would capture and upload snapshot image or video. Such automation could be controlled by the PIR 302 and the IP camera 301 themselves, by the home gateway 350, or by the cloud server 360 according to the selected Rule 1. Likewise, the home gateway 350 or the cloud server 360 can select the suitable automation rule Rule 2 that can be adopted for the second IP camera 311 and the second PIR sensor 312. Since the first IP camera 301 and the second IP camera 311 have the same type and the first PIR sensor 302 and the second PIR sensor 312 have the same type, the automation rule Rule 2 and the automation rule Rule 1 can be the same.

In the embodiment as indicated in FIG. 5, the candidate automation rules are stored in the cloud server 360. The advantage is that the home gateway 350 needs not to update the candidate automation rules often, and when the selection of the automation rule is required, the selection can be completed with the assistance of the cloud server 360. For a service provider, whenever a new product is developed (for example, a new type is generated) or the relevant candidate automation rules need to be amended, the service provider can make necessary addition or update on the cloud server 360. Thus, the candidate automation rules can be easily augmented without adding extra burden to the home gateway 350.

In the automation rule selection method and the wireless communication device disclosed in above embodiments, location indicators of the devices are first examined to determine whether to proceed with rule selection, and then the suitable automation rule can be selected from the candidate automation rules according to the type indicators of the devices. Thus, the difficulty in user setting is reduced. At most the user only needs to give the suitable location indicator after the device installation is completed, and the rest will be automatically done by the system. The user does not need to set the automation rule between the devices pair by pair, not only simplifying the setting but also reducing unnecessary setting errors.

The automation rule selection method of the invention includes: determining whether the location indicators satisfies the location restraint. Therefore, device pairs not satisfying the location restraint are excluded, and the computation burden of selecting automation rule can be effectively reduced. For example, suppose the user has two smart home devices installed at each of five rooms. If the location indicators are not taken, 45 times of search are required to search all possible automation rules between any pair of smart home devices. On the contrary, if the location indicator is taken into consideration, only 5 times of search are required to search all possible automation rules between two smart home devices at each same room.

Since the automation rule selection method of the invention performs selection according to the type indicators, and the expression of the automation rule can be suitably simplified (that is, devices of the same type are classified under the same automation rule), the number of automation rules that need to be stored is decreased, and the searching time for the automation rules can be reduced.

While the invention has been described by way of example and in terms of the preferred embodiment(s), it is to be understood that the present disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automation rule selection method, comprising:
obtaining a first type indicator and a first location indicator of a first device;
obtaining a second type indicator and a second location indicator of a second device; and
selecting an automation rule from a plurality of candidate automation rules according to the first type indicator and the second type indicator, if the first location indicator and the second location indicator satisfy a location restraint.

2. The automation rule selection method according to claim 1, further comprising:
adopting the selected automation rule for the first device and the second device.

3. The automation rule selection method according to claim 1, wherein the location restraint comprises that the first location indicator and the second location indicator indicate that the first device and the second device belong to the same region.

4. The automation rule selection method according to claim 1, wherein the location restraint comprises that the first location indicator and the second location indicator indicate that a distance between the first device and the second device is smaller than a distance threshold.

5. The automation rule selection method according to claim 1, further comprising:
obtaining the plurality of candidate automation rules through a network connection.

6. A wireless communication device, comprising:
a signal transceiver used for obtaining a first type indicator and a first location indicator of a first device and obtaining a second type indicator and a second location indicator of a second device; and
a processor electrically coupled to the signal transceiver and used for performing following operations:
determining whether the first location indicator and the second is location indicator satisfy a location restraint, and selecting an automation rule from a plurality of candidate automation rules according to the first type indicator and the second type indicator if the first location indicator and the second location indicator satisfy the location restraint.

7. The wireless communication device according to claim 6, wherein the signal transceiver is further used for transmitting the automation rule to the first device and the second device so as to adopt the selected automation rule for the first device and the second device.

8. The wireless communication device according to claim 6, wherein the location restraint comprises that the first location indicator and the second location indicator indicate that the first device and the second device belong to the same region.

9. The wireless communication device according to claim 6, wherein the location restraint comprises that the first location indicator and the second location indicator indicate that a distance between the first device and the second device is smaller than a distance threshold.

10. The wireless communication device according to claim 6, wherein the signal transceiver is further used for obtaining the plurality of candidate automation rules through a network connection.
